(19) United States
(12) Patent Application Publication
(10) Pub. No.: US 2007/0239621 A1
(43) Pub. Date: Oct. 11, 2007

(54) Low cost, secure, convenient, and efficient way to reduce the rate of fraud in financial and communication transaction systems

(76) Inventor: Igor Igorevich Stukanov, Toronto (CA)

Correspondence Address: IGOR STUKANOV, SUITE 405, 66 OAKMOUNT ROAD, TORONTO, ON, M6P 2M8, US

(21) Appl. No.: 11/716,733

(22) Filed: Mar. 12, 2007

Related U.S. Application Data
(60) Provisional application No. 60/790,855, filed on Apr. 11, 2006.

(51) Int. Cl. H04L 9/00

(52) U.S. Cl. 705/72

(57) ABSTRACT

A low-cost, secure, reliable, convenient, and efficient way to reduce the rate of fraud by means of using additional PINs/passwords, which are dynamic PINs delivered periodically via different channels, defined by users, with a changing pre-defined by the user periods.

### CROSS-REFERENCE TO RELATED APPLICATIONS

This application claims priority status of provisional patent application U.S. 60/790,855

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Field of the Invention

This invention relates to a method and system, which allow significantly increase security of transactions and reduce rate of fraud in low cost, convenient for users and efficient way.

2. Background Information

Fraud with transactions in customer present and non present environments such as on-line financial transactions, credit/debit card transactions, mobile communication transactions, etc. is a big problem, which increase costs of doing businesses, damage reputation, image and brand of businesses and governments.

Despite significant efforts in reducing fraud rates, the problem is becoming bigger due to new opportunities to commit fraud and identity theft. There are methods, which reduce fraud rate for the cost of inconvenience for users (so these methods are secure, but are not convenient for users), there are also convenient methods but not secure or cost efficient enough. The problem of finding a highly secure, low-cost, efficient, and convenient for users method is still open.

U.S. Pat. No. 5,311,594 describes a method where randomly selected piece of pre-stored information, such as birthday of spouse or year of school graduation is used to increase security of transactions. Such system can be easy compromised when unauthorized users will know this pre-stored information. As far as there are many places/databases where such information is available it cannot be considered as a secure solution. There are no options to quickly recover the system, once it compromised.

US patent application 20010034720 describes a system and method, where a secondary transaction number is used to increase security of the transaction. Such system has no mechanism to secure transactions in the case if the secondary transaction number will be compromised or unauthorized user will be able to get access to the account.

U.S. Pat. No. 6,908,030 describes a method, where a one-time number is used for authentication. The problem with this method is inconvenience for users in replacing used numbers.

U.S. Pat. No. 5,060,263 describes a system in which dynamic passwords are generated by autonomous device/token. This system is secure and convenient for users, which explain its wide usability, but it also has no protection in the case if the issuer will be compromised. The cost of replacement of millions of tokens, in this case, is huge. There are also problems with tokens. If a user looses a token she/he will not be able to make transactions until the token will be replaced. These tokens may be damaged by radiation, heat, mechanical pressure, etc., which result in non-correct generation of the passwords.

The purpose of the current invention is to suggest a highly secure, reliable, low-cost, and convenient for users method and system, which is described below.

### BRIEF SUMMARY OF THE INVENTION

A low cost, reliable, convenient and efficient way to reduce the rate of fraud is to increase security of transactions by means of additional PINs/passwords, which are dynamic PINs delivered periodically via different channels with changing periods and channels specified by an account holder. These PINs are required to endorse the transaction. The account holder may specify a number of these PINs, time period for new PINs generation, channels for delivery (for example e-mails, mobile phones, regular phones, PDAs, fax, tv, skype, etc.) of these PINs to the account holder.

Regularly new PINs are generated and delivered via the selected channels to the account holder. The account holder may use all or part of these PINs in endorsing a transaction using a selected method in customer non-present environment, for example a credit/debit card over internet. These PINs are valid only on the current time interval (month, week, day, hour, minute, etc.). It is not possible to use these PINs on the next time interval.

### BRIEF DESCRIPTION OF THE SEVERAL VIEWS OF THE DRAWINGS

FIG. 1. A sample of simple user setup security setting page

FIG. 2. A sample of an order page

FIG. 3. A sample of an access report page

### DETAILED DESCRIPTION OF THE INVENTION

The present invention is directed to a method and system, which allow significantly increase security of transactions and reduce rate of fraud in low cost, convenient for users and efficient way; and is described below in a one example.

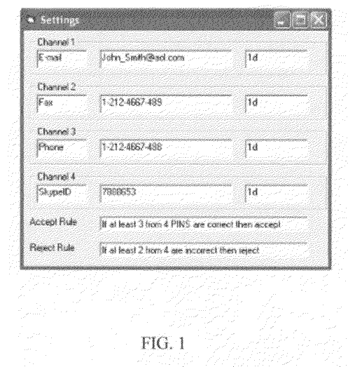

FIG. 1 shows simplified interface, where a user may select settings for the described in this document system. The user may select different type of channels, and channels IDs. As shown on this figure, the user had selected e-mail, fax, Skype and phone as type of channels and specific e-mail addresses, fax and phone numbers, SkypeID as as the channels IDs, via which the dynamically generated PINs will be delivered to the user.

The user also had selected periodicity, with which the dynamically generated PINs will be delivered to the user via the specified channels. In this example the period was chosen of a one day. It means that every day new PINs will be generated, which can be used to accept transactions during this day. If PINs entered on order form will be different from these generated PINs the transaction will be rejected according to the rejection rule.

The user may specify rules for acceptance or rejections of transactions.

In this example the user had selected the following rule for accepting transactions—“if at least 3 from 4 PINs are correct then accept a transaction” and the following rule for rejecting transactions—“if at least 2 from 4 are incorrect then reject a transaction”

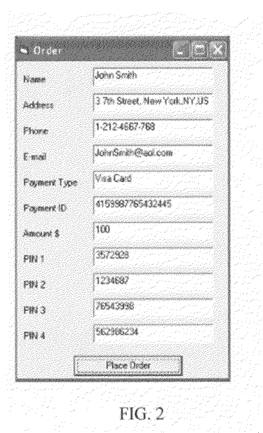

FIG. 2 shows an order form. This form asks a customer to enter the PINs, which will be used to accept or reject this transaction. If a customer enters at least three PINs from the four PINs correctly then the transaction will be accepted according to the “acceptance” rule.

If a customer enters less than three correct on this day PINs then the transaction will be rejected.

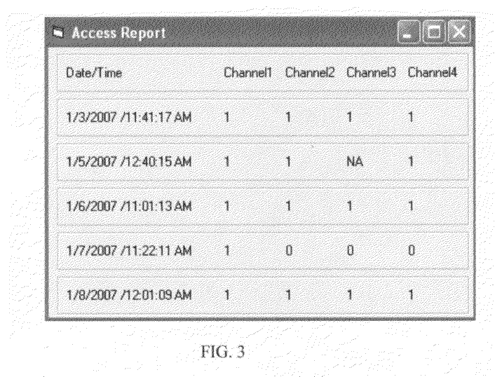

FIG. 3 shows an access report form. This form allows a user to monitor reliability of channels and usage of PINs. If a user discovers a compromised channel she/he can quickly change it or disable it. For example, on the FIG. 3 it shown that on Jan. 7, 2007 at 11:27:11 AM was an attempt to make a transaction. The transaction was rejected, but the PIN for the first channel was correct, which means that this channel was compromised.

1. A low-cost, highly reliable, convenient for users method and system for increasing security of transactions and reducing fraud rates comprising the following steps:
a. An account or card holder select a number of additional PINs, the account/card numbers, time periods for automatic generation of new PINs and account/card numbers, and communications channels via which these numbers and PINs will be periodically delivered to the account/card holder. These parameters are secured in the system.
b. Periodically, with the periods specified by the account/card holder for the account and each PIN, new numbers are generated and delivered automatically by the system to the account/card holder via the different specified by the holder communications channels, such as e-mail, phone, fax, tv, mobile, wireless PDA, SkypeID, etc. The account/card number and PINs are valid only on the time periods specified by the account/card holder. Each number may be delivered via one or several channels and has own time period of validity.
c. The account/card holder gets these numbers and uses them to endorse a transaction.
d. The transaction is accepted for processing if the account/card number and all or specific PINs entered in the transaction are the correct numbers for this time interval.
e. The transaction is rejected if the account/card number or specific PINs in the transaction are incorrect for this time interval.

2. A method and system as in claim 1, where instead of numbers, combinations of numbers and symbols are used.

3. A method and system as in claim 2, where a one part of the account/card number may be fixed and the other may be dynamically changed with the period specified by the account/card holder.

4. A method and system as in claim 3, where a random generator generates PINs.

5. A method and system as in claim 3, where an algorithm generates PINs.

6. A method and system as in claim 3, where dynamically generated accounts/cards numbers and PINs are stored in the system's secured database.

7. A method and system as in claim 3, where dynamically generated accounts/cards numbers and PINs are not stored in the system.

8. A method and system as in claim 3, where a transaction is a financial transaction.

9. A method and system as in claim 3, where a transaction is a communication transaction.

10. A method and system as in claim 3, where the users may specify specific rules for accepting or rejecting transactions.
